(19) United States
(12) Patent Application Publication
(10) Pub. No.: US 2006/0092380 A1
(43) Pub. Date: May 4, 2006

(54) Clean-up polarizer and gamma control for display system

(76) Inventors: Kenneth E. Salsman, Pleasanton, CA (US); Anders Grunnet-Jepsen, San Jose, CA (US)

Correspondence Address: INTEL CORPORATION, P.O. BOX 5326, SANTA CLARA, CA, 95056-5326, US

(21) Appl. No.: 10/981,396

(22) Filed: Nov. 4, 2004

(51) Int. Cl. G03B 21/14; G02F 1/1335

(52) U.S. Cl. 353/20

(57) ABSTRACT

In some embodiments, an optical engine for a display system utilizes a wire grid clean-up polarizer for polarization cleanup. In some embodiments, a liquid crystal component, separate from the spatial light modulator, is utilized for gamma control. Other embodiments are disclosed and claimed.

The invention relates to display systems and more particularly to a clean-up polarizer and a gamma control component for display systems.

### BACKGROUND AND RELATED ART

Wire grid polarizers (WGPs) are well known in the art. The use of a WGP as a polarizing beam splitter in a display system is discussed, for example, in U.S. Pat. No. 6,779,893. In general, gamma control refers to compensating for a non-uniformity in the display system. For example, a spatial light modulator may have a non-linear photopic gray scale response, which may be characterized by a non-linear gamma curve.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a schematic diagram of a display system in accordance with some embodiments of the present invention.

FIG. 2 is a block diagram of a method of operation in accordance with some embodiments of the present invention.

FIG. 3 is a schematic diagram of another display system in accordance with some embodiments of the present invention.

FIG. 4 is a graph of LCOS contrast versus base optical contrast.

FIG. 5 is a schematic diagram of another display system in accordance with some embodiments of the present invention.

FIG. 6 is a schematic diagram of another display system in accordance with some embodiments of the present invention.

FIG. 7 is a schematic diagram of another display system in accordance with some embodiments of the present invention.

FIG. 8 is a schematic diagram of a gamma control system in accordance with some embodiments of the present invention.

FIG. 9 is a schematic diagram of another gamma control system in accordance with some embodiments of the present invention, including an integrated clean-up polarizer.

FIG. 10 is a schematic diagram of another display system in accordance with some embodiments of the present invention.

FIG. 11 is a schematic diagram of another display system in accordance with some embodiments of the present invention.

FIG. 12 is a block diagram of another method of operation in accordance with some embodiments of the present invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

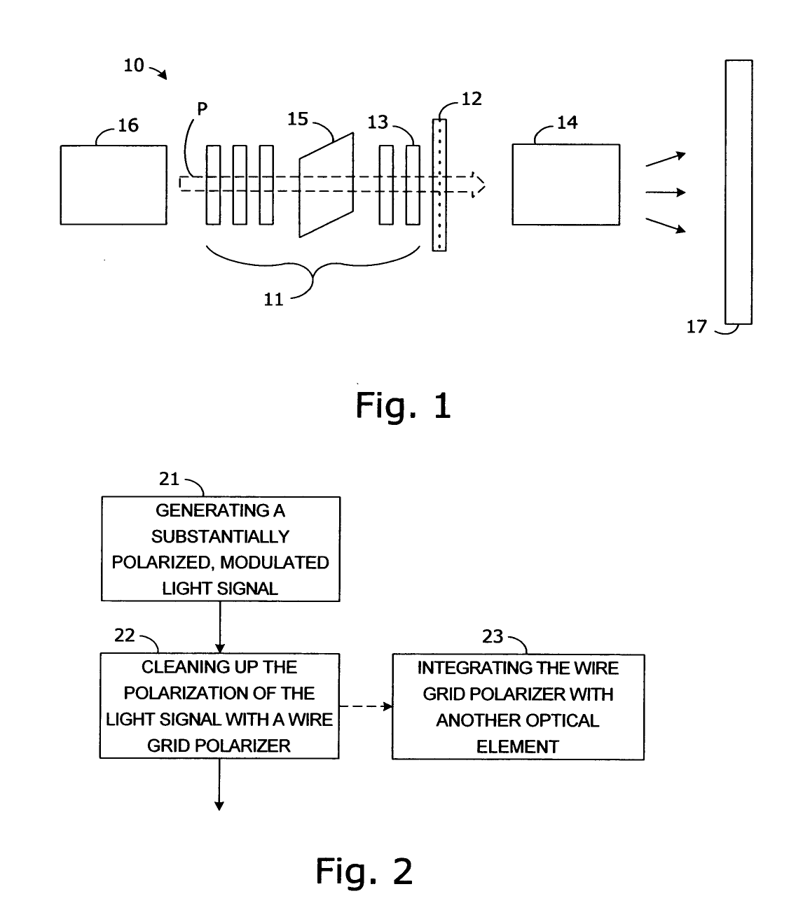

With reference to FIG. 1, in some embodiments of the present invention one or more optical components 11 may be disposed along an optical path P. A clean-up polarizer 12 may be disposed along the optical path P with the one or more optical components 11, wherein the clean-up polarizer 12 comprises a wire grid clean-up polarizer. For example, the optical components 11 may include one or more lenses, filters, color switching components, polarizers, and / or prisms, among other optical components which find utility in a display system. For example, an optical component 13 may include a prism and the wire grid clean-up polarizer 12 may be disposed on a face of the prism 13. The wire grid clean-up polarizer 12 may receive light incident thereon which is already substantially polarized by one or more of the other optical components 11 in the optical path P. In some embodiments, an optical component along the optical path P may include a projection lens 14 and the wire grid clean-up polarizer 12 may be positioned proximate to an entrance aperture of the projection lens 14.

In some embodiments, a display system 10 may include a spatial light modulator 15 disposed along the optical path P and configured to modulate light, and the wire grid clean-up polarizer 12 may be disposed along the optical path P with the spatial light modulator 15. For example, non-limiting examples of spatial light modulators include transmissive and reflective liquid crystal display (LCD) devices, micro-electronic mechanical systems (MEMS) devices, micro-mirror devices, and liquid crystal on silicon (LCOS) devices. The system 10 may further include a light engine 16 configured to provide light along the optical path P. The light from the light engine 10 may be acted on by the various optical components 11 along the optical path P, including the spatial light modulator 15. An output beam from the wire grid clean-up polarizer 12 may enter the projection lens 14 to be projected on a display screen 17 configured to display an image of the modulated light from the spatial light modulator 15. Although illustrated as substantially linear, the optical path P may bend or reflect in accordance with the physical arrangement of the components in the display system 10.

With reference to FIG. 2, some embodiments of the present invention may include generating a substantially polarized, modulated light signal (block 21), and cleaning up the polarization of the light signal with a wire grid polarizer (bock 22). Some embodiments may further include integrating the wire grid polarizer with another optical element (block 23). For example, the optical element may include a prism.

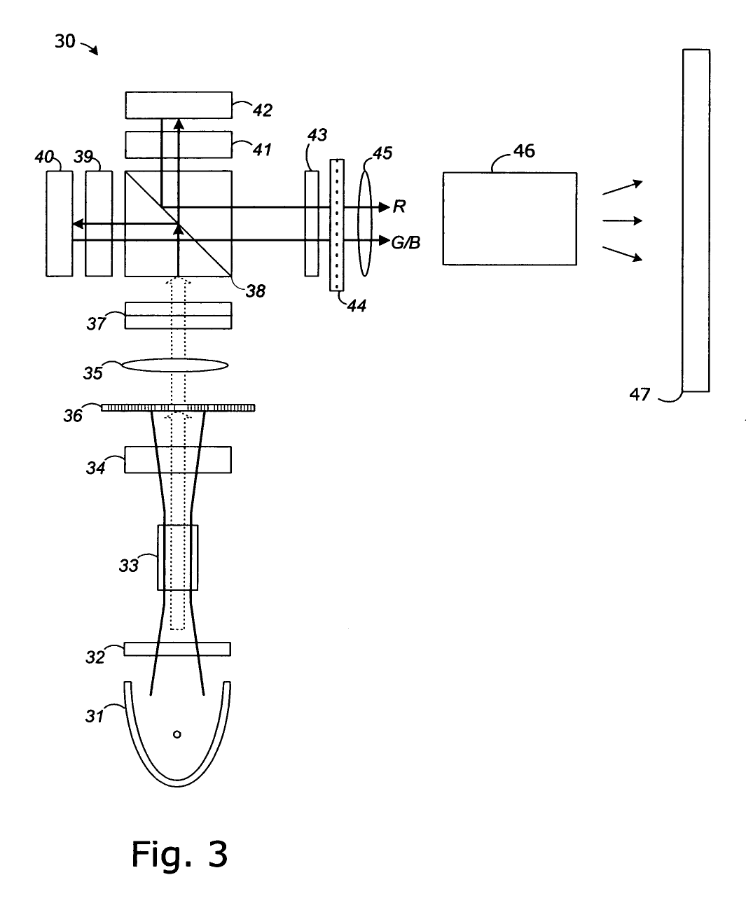

With reference to FIG. 3, a display system 30 may utilize a light source 31, such as an ultra high-pressure (UHP) lamp 31 to provide light. At the output region of the light source 31, a set of optical components may be disposed, forming an input light beam. For example, the set of optical components may include an ultraviolet and infrared (UV-IR) filter 32, a light pipe homogenizer 33, a color switch or color wheel 34, and a lens 35. However, many of these optical components may have alternate forms. In the configuration shown in FIG. 3, a conventional polarizer, such as an output polarization analyzer 36 may serve to pass the light of a first polarization “P” while skipping or reflecting the light of a second polarization “S.” The color switch 34 in combination with the output polarization analyzer 36 may ideally pass red light through at all times, for example, and selectably switch or alternate between either passing blue light and reflecting green light or passing green light and reflecting blue light.

The display system 30 may further include an imaging pre-filter, i.e., an RC1 filter 37 which is deployed in the output region of the lens 35. A polarization beam splitter (PBS) 38 with a first side facing the RC1 filter 37 may additionally be provided thereafter. In the same way, on a second side of the PBS 38, a quarter-wave retarder 39 and a first spatial light modulator (SLM) 40 may be located. Yet another quarter-wave retarder 41 and a second SLM 42 may be provided on a third side of the PBS 38. For example, the input polarization beam splitter (PBS) 38 may comprise a MacNeille PBS or a wire grid plate PBS, among other suitable choices for the PBS 38. In operation, an electronic drive signal may present image data to the first SLM 40 that alternates between blue and green image data, while the second SLM 42 may be presented only with red image data. A clean-up polarizer 44, and a projection lens 46 may be configured on a fourth side of the PBS 38 to provide an output beam to a display screen 47 based on a particular electronic drive signal, presenting image data in a specific format including a red-bluegreen (RGB) format, as one example. Additional optical components 43 and 45, such as lenses and/or filters, may be provided along the optical path. In accordance with some embodiments of the present invention, the clean-up polarizer 44 is made from or includes a wire grid polarizer (WGP), and may be referred to as a wire grid clean-up polarizer 44.

Taken together, the display system 30 may be said to include a light engine (e.g. incorporating the elements 31, 32 and 33), a color switch subsystem (e.g. including the elements 34, 35 and 36), an imaging subsystem or kernel (e.g. comprising the elements 37 through 45), and a projection subsystem (e.g. including elements 46 and 47).

Some optical projection systems that utilize display devices, such as liquid crystal display (LCD) devices that control the polarization of light, may have a contrast limit that inhibits the contrast of the display devices from being translated to the viewer without a significant reduction in contrast. For example, leakage of light with the incorrect polarization, onto the display devices and/or into the output beam may cause undesirable degradation of a projected image in a panel-based color imaging display system. A typical rule of thumb for system contrast ratio (SC) may be: 1/SC=1/BC+1/DC; where SC corresponds to the system contrast ratio, BC corresponds to the base engine contrast ratio, and DC corresponds to the display contrast ratio. Optical engines may have their base engine contrast measured with a mirror for saturated white (as an example) and a mirror with a quarterwave plate for black (as an example, replacing the display device for measurement purposes).

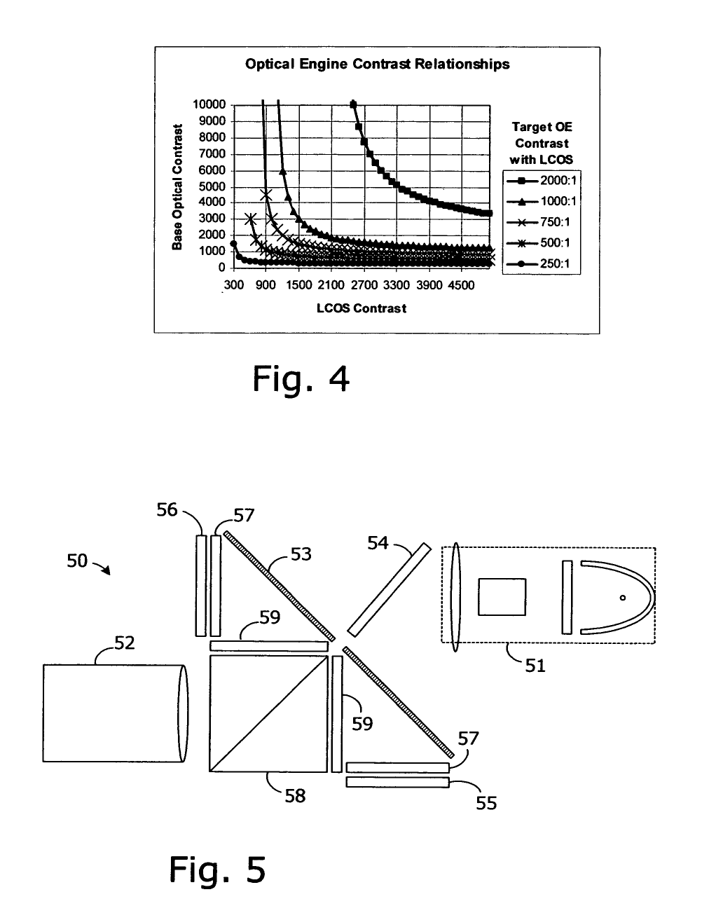

FIG. 4 shows a family of system contrast curves for various combinations of engine base contrast ratios and display contrast ratios. For example, an optical engine using a polarizing beam splitter to direct light by its polarization orientation may provide an engine base contrast (BC) of about 2500:1. For an example liquid crystal on silicon (LCOS) display system having a display contrast ratio (DC) of about 1000:1, the result is a system contrast (SC) of about 714:1.

Much of the loss in contrast ratio may be due to light traveling through the system in uncontrolled polarization states and creating a black level that may actually have some gray component. In some display system, organic clean-up polarizers may be provided between the display elements and the projection lens that may provide some improvement in blocking light of the wrong polarization. However, the applicants have discovered that a clean-up polarizer comprising an appropriately configured wire grid polarizer may provide a substantial improvement in base engine contrast (and consequently system contrast) as compared to a conventional organic clean-up polarizer.

With reference to FIG. 5, a display system 50, utilizing a WGP as the clean-up polarizer, in accordance with some embodiments of the invention, may provide a dramatic improvement in system contrast as compared to a similarly configured display system utilizing organic clean-up polarizers. The display system 50 includes a light engine 51 and a projection subsystem 52, and utilizes a wire grid polarizer 53 as a polarization beam splitter. Light from the light engine 51 is directed to a red dichroic mirror 54 which reflects red light through the WGP 53 to a first LCOS panel 55 and passes blue and green light through the WGP 53 to second LCOS panel 56. The LCOS panels 55, 56 may have associated additional optical components 57, such as filters, lenses, etc. A color switch subsystem (not shown) may switch blue and green light on the second LCOS panel 56.

Substantially polarized, modulated light from the first and second LCOS panels 55, 56 is reflected by the opposite side of the WGP 53 onto respective faces of a combining prism 58. In accordance with some embodiments of the invention, and as illustrated in FIG. 5, wire grid clean-up polarizers 59 are disposed on each of the respective faces of the combining prism 58 which receive the substantially polarized, modulated light from the respective panels. Alternatively, a single wire grid clean-up polarizer may be disposed on an exit face of the combining prism 58, proximate to the entrance aperture of the projections lens 52.

The wire grid clean-up polarizer(s) 59 may reflect light of the wrong polarization back into the optical engine (e.g. various of components 53-58). In some embodiments, the wire grid clean-up polarizer(s) 59 may be configured to lie outside a focal plane within the optical engine so the reflected light is not refocused onto an imaging surface.

Conventionally, organic films have been used as clean-up polarizers. For example, it may have been an assumption by those skilled in the art that lower performing filters for cleanup were acceptable because the light was sufficiently polarized by the displays and previous optics. However, applicants have discovered that this is not the case for systems at extremely high contrast and to achieve a higher level of performance the light should be made more pure in its polarization state.

For example, beam splitters, prisms and displays all interact with the light in manners that may produce polarization leakage (e.g. light that is not fully linearly polarized in a specific orientation) that is slightly elliptical. This ellipticity may result in black pixels having some low level of light in them and reduces the overall contrast that the projection system can achieve. In accordance with some embodiments of the invention, the use of a high performance polarizer, such as the WGP, in the system as a cleanup polarizer provides the ability for the system to operate at higher contrast and results in a system that has little or no loss in transmitting the contrast of the display to the screen for the user to view.

In the example of FIG. 5, the wire grid clean-up polarizer(s) 59 can provide a very high filtering function on the light being transmitted to the projection lens 52. Because the light incident on the wire grid clean-up polarizer(s) 59 is already substantially polarized by the WGP 53, the LCOS panels 55, 56 and/or other optical components in the optical path, the wire grid clean-up polarizer(s) 59 may have little detrimental impact on the brightness of the display system 50. However, advantageously, the wire grid clean-up polarizer(s) 59 may have a significant positive impact on the amount of light that leaks out in pixels that are driven black.

An example system utilizing a wire grid polarizer for the polarization beam splitter and conventional organic clean-up polarizers near the projection lens has been measured to provide an engine base contrast (BC) of about 10,000:1. Advantageously, an example system in accordance with some embodiments of the present invention utilizing a WGP clean-up polarizer near the projection lens has been measured to provide an engine base contrast (BC) of about 20,000:1, essentially double the above-noted engine base contrast for a comparably equipped display system utilizing organic clean-up polarizers. At the high contrast provided by some embodiments of the present invention, an appropriately configured display system may be capable of projecting substantially the full contrast of the display devices with little or no significant loss in contrast.

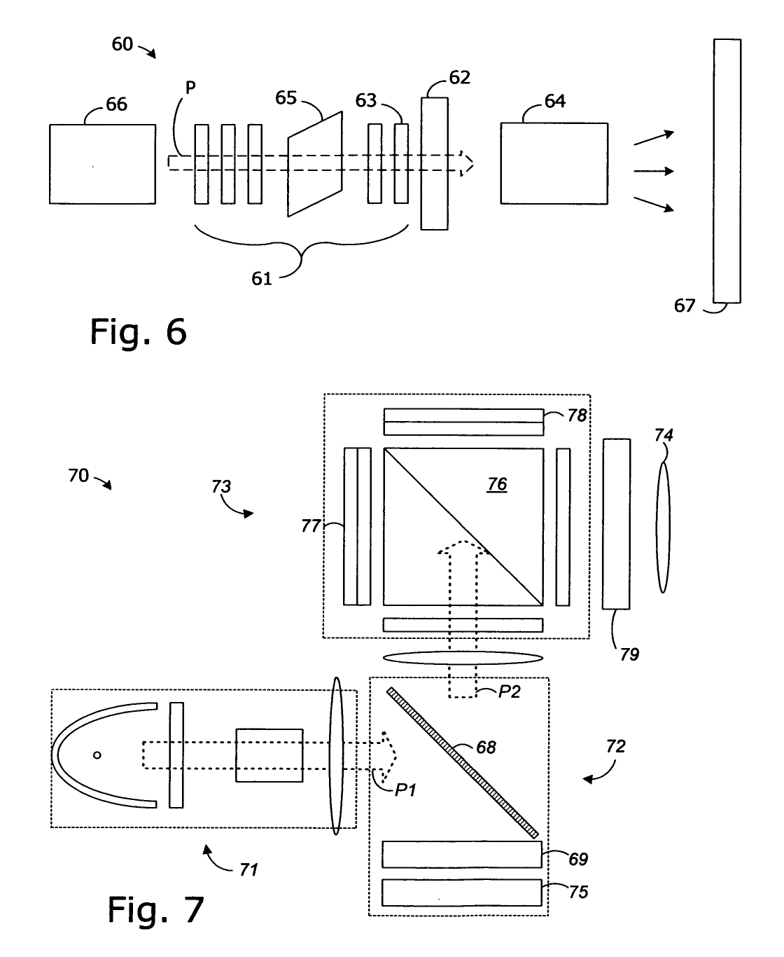

With reference to FIG. 6, in some embodiments of the present invention one or more optical components 61 may be disposed along an optical path P. A gamma control component 62 may be disposed along the optical path P with the one or more optical components 61. For example, the gamma control component 62 may include a liquid crystal component separate from any spatial light modulator in the optical path P. For example, the optical components 61 may include one or more lenses, filters, color switching components, polarizers, and/or prisms, among other optical components which find utility in a display system. For example, an optical component 63 may include a prism and the gamma control component 62 may be disposed on a face of the prism 63. For example, another optical component along the optical path P may include a projection lens 64 and the gamma control component 62 may be positioned proximate to an entrance aperture of the projection lens 64.

In some embodiments, a display system 60 may include a spatial light modulator 65 disposed along the optical path P and configured to modulate light, and the gamma control component 62 disposed along the optical path P with the spatial light modulator. The system 60 may further include a light engine 66 configured to provide light along the optical path P. The light from the light engine 60 may be acted on by the various optical components 61 along the optical path P, including the spatial light modulator 65. An output beam from the gamma control component 62 may enter the projection lens 64 to be projected on a display screen 67 configured to display an image of the modulated light from the spatial light modulator 65. Although illustrated as substantially linear, the optical path P may bend or reflect in accordance with the physical arrangement of the components in the display system 60.

In many conventional systems, a display device (e.g. an SLM) may typically produce an 8 bit gray scale image (i.e. 256 distinct levels of gray). However, the necessity for the image to have a non-linear photopic gamma (e.g. gray scale ramp) may require that the display device have the capability to produce this non-linear gamma curve and therefore additional bits of gray scale control are required. Including extra bits of gray scale control in the display device may require additional circuitry and consequently may lower the yield of the display device in production.

For example, in many conventional projection display systems, the display device is used to produce a gray scale gamma curve to present the image in a desired colorimetry for the viewer. In conventional systems, an expensive part of the system, the active matrix display, may be designed to be capable of not only 8 bits of gray scale control but also to be capable of producing that control in non-linear stepping or gamma curves. The non-linear gamma control may require 15 bits or more of data control to produce an 8 bit gray scale image.

Advantageously, in accordance with some embodiments of the invention, activities that may be better done digitally (e.g. matrix display and bit-wise gray scale control) may be separated from activities that may be better done in either analog circuits or digitally (e.g. implementing non-linear gamma curves). For example, in accordance with some embodiments of the invention, the incorporation of a gamma control component separate from the pixilated display device allows a non-linear gamma curve to be implemented outside of the display device and consequently reduces the complexity and cost of the more complex drive scheme within the display device(s) or in other elements of the display system.

With reference to FIG. 7, a panel-based color imaging display system 70 includes an illumination subsystem 71, a color switch subsystem 72, an imaging subsystem 73, and a projection lens 74. The system 70 may include an optical path in which an output axis P1 of the illumination subsystem 71 is in a non-collinear relationship with an input axis P2 of the imaging subsystem 73. For example, the illumination subsystem 71 may include a light source, a homogenizer, and various lenses and/or filters. The color switch subsystem may include a polarization beam splitter (PBS) 68, a color switch device 69, such as a color wheel, and a turn-around polarizer 75. The imaging subsystem 73 may include a combining prism 76, two LCOS panels 77, 78, and various filters and/or clean-up polarizers.

In accordance with some embodiments of the invention, a gamma control component 79 is positioned in the optical path between the imaging subsystem 73 and the projection lens 74. For example, the gamma control component 79 may be positioned near an entrance aperture of the projection lens 74. Alternatively, the gamma control component of some embodiments of the invention may be placed at any of a number of locations in the optical path as may be necessary or desirable for particular applications. For example, the gamma control component 79 may alternatively be located between any of the illumination sub-system, the color switch subsystem, the imaging sub-system, and the projection subsystem, or at suitable locations within those subsystems. Advantageously, the gamma control component 79 separates the gamma control function from the imaging function and the two LCOS panels 77, 78 may include little or no gamma control circuitry, thereby reducing overall complexity and cost for the active display devices.

In some embodiments, the display system 70 may utilize the conventional organic clean-up polarizers. However, the display system 70 preferably utilizes wire grid clean-up polarizers as described above in connection with FIGS. 1-5. The gamma control component 79 and the clean-up polarizers may be provided separately along the optical path, or may be integrated as described in detail below.

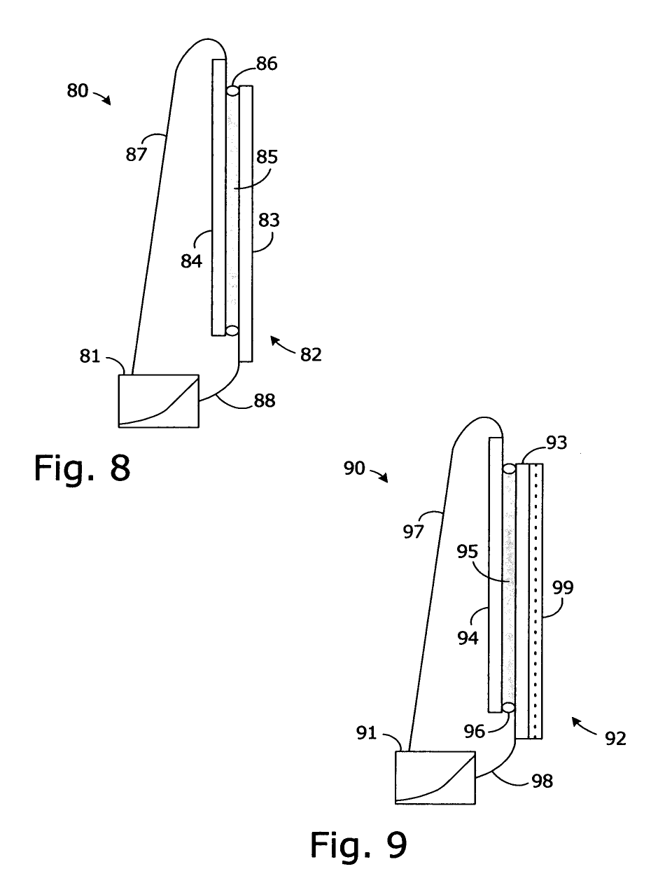

With reference to FIG. 8, an example gamma control component 80 may comprise a gamma ramp generator circuit 81 coupled to a single pixel liquid crystal (LC) cell 82, which may be a transmissive liquid crystal cell. The liquid crystal cell 82 includes a first layer of glass (e.g. glass substrate 83) and a second layer of glass (e.g. glass substrates 84) containing liquid crystal material 85 disposed in between the first and second layers of glass. The liquid crystal material 85 may be sealed in the liquid crystal cell 82, for example, with an epoxy bead 86 provided between the substrates 83, 84 and surrounding the material 85. Each of the substrates 83 and 84 may respectively bear indium-titanium oxide (ITO) coatings to provide substantially transparent electrodes thereon. The electrodes of the LC cell 82 may be respectively connected to the gamma ramp generator circuit 81 by respective electrical connections, for example, by conductive wires.

The transparency of the LC cell 82 may be controlled by relative voltages applied between the two electrodes. The gamma ramp generator circuit 81 may be an analog circuit, a digital circuit, or a combination thereof configured to provide the appropriate voltages on the electrodes. In some embodiments, the gamma ramp generator circuit 81 provides a non-linear electrical signal to the liquid crystal component 82 in accordance with a desired gamma curve. The gamma curve may be programmable. In some embodiments, a spatial light modulator, separate from the single pixel liquid crystal cell 82, may be disposed along an optical path with the single pixel liquid crystal cell 82.

For example, the gamma ramp generator circuit 81 may include a memory circuit storing digital data representative of the desired gamma control curve and a digital-to-analog (D/A) converter. The digital data may be read out of the memory circuit and operated on (e.g. by a processor or a micro-controller) to determine an appropriate voltage corresponding the stored digital data. One of the electrodes of the LC cell 82 may be grounded and the D/A converter may then be configured to output the appropriate voltage on the other electrode. Those skilled in the art will appreciate the foregoing as one example of numerous possible configuration for the gamma ramp generator circuit 81.

Advantageously, the gamma control component may be programmable so that the same gamma control component may be used with a variety of display devices and/or display system configurations. For example, after determining an appropriate gamma curve for a particular display system configuration, the memory of the gamma ramp generator circuit described above may be updated with appropriate digital data representing the desired gamma curve. The memory circuit may be volatile and the data stored therein after power is supplied to the circuit, but preferably is the data is stored in a non-volatile memory circuit such as flash memory.

In accordance with some embodiments of the invention, a single active gamma control component may produce a variable range of gamma curves by simple programming. For example, the gamma control component may be programmed to produce non-linear user definable gamma curves that increase the range of system performance and generate colorimetry in images selected to best match the human vision system. Advantageously, the programmable gamma control component reduces the digital control burden of the display device. For example, the display device may run at lower clock speeds, use less transistors, produce less heat, and/or achieve higher yield and lower cost.

With reference to FIG. 9, some embodiments of the invention incorporate both polarization clean-up and gamma control in one component. An example integrated polarization clean-up and gamma control component 90 may comprise a gamma ramp generator circuit 91 coupled to a single pixel liquid crystal (LC) transmissive cell 92. The liquid crystal cell 92 includes two glass substrates 93 and 94 containing liquid crystal material 95 therebetween. The liquid crystal material 95 may be sealed in the liquid crystal cell 92, for example, with an epoxy bead 96 provided between the substrates 93, 94 and surrounding the material 95. Each of the substrates 93 and 94 may be indium-titanium oxide (ITO) coated to provide substantially transparent electrodes. The electrodes of the LC cell 92 may be respectively connected to the gamma ramp generator circuit 91, for example, by conductive wires. A wire grid clean-up polarizer 99 may be disposed on a face of one of the two glass substrates (e.g. on substrate 93).

When the gamma control component is integrated with the polarization clean-up component, the integrated component should be positioned in the optical path at a location suitable for both components. For example, in most applications the integrated gamma control and wire grid clean-up polarizer may be positioned between the imaging subsystem and the projection subsystem (e.g. near an entrance aperture for the projection lens).

Advantageously, some embodiments of the integrated the gamma control and wire grid clean-up polarizer may utilize surfaces or structures already present in the optical engine to reduce the part count and/or manufacturing steps required to make the optical engine. In some embodiments, the wire grid clean-up polarizer may include electrically conductive wires that may have a voltage applied thereto to function as one electrode of the LC cell for gamma control. In some embodiments, the wire grid clean-up polarizer may include a glass substrate, and an adjacent optical component (e.g. the combining prism) may include a glass face. The LC cell for gamma control may include LC material contained between these two pre-existing glass surfaces sealed with an epoxy bead. For example, in some embodiments the exit face of the combining prism may be ITO coated to provide one electrode of the LC cell and the wire grid of the WGP may be conductive to provide the other electrode of the LC cell. Alternatively, both glass surfaces may be ITO coated to provide the LC cell electrodes.

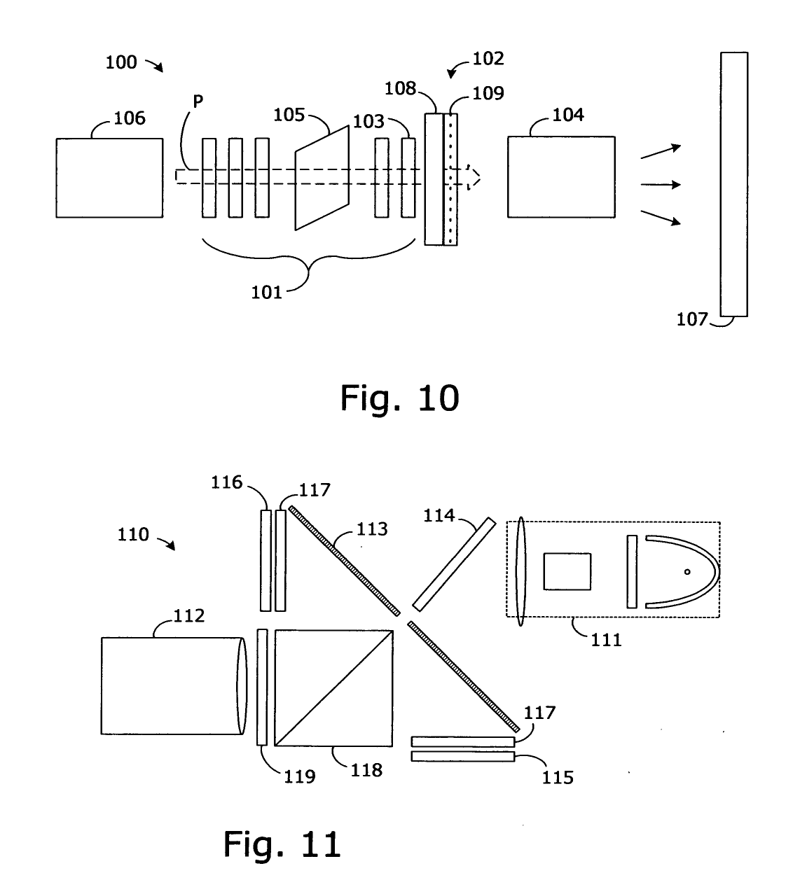

With reference to FIG. 10, in some embodiments of the present invention one or more optical components 101 may be disposed along an optical path P. An integrated gamma control and wire grid clean-up polarizer component 102 may be disposed along the optical path P with the one or more optical components 101, wherein the integrated component 102 comprises both a gamma control component 108 and a wire grid clean-up polarizer 109. For example, the integrated component 102 may be constructed as described above with respect to FIG. 9.

The optical components 101 may include one or more lenses, filters, color switching components, polarizers, and/or prisms, among other optical components which find utility in a display system. For example, an optical component 103 may include a prism and the integrated component 102 may be disposed on a face of the prism 103. The integrated component 102 may receive light incident thereon which is already substantially polarized by one or more of the other optical components 101 in the optical path P. In some embodiments, an optical component along the optical path P may include a projection lens 104 and the integrated component 102 may be positioned proximate to an entrance aperture of the projection lens 104.

In some embodiments, a display system 100 may include a spatial light modulator 105 disposed along the optical path P and configured to modulate light, and the integrated component 102 may be disposed along the optical path P with the spatial light modulator 105. The system 100 may further include a light engine 106 configured to provide light along the optical path P. The light from the light engine 100 may be acted on by the various optical components 101 along the optical path P, including the spatial light modulator 105. An output beam from the integrated component 102 may enter the projection lens 104 to be projected on a display screen 107 configured to display an image of the modulated light from the spatial light modulator 105. Although illustrated as substantially linear, the optical path P may bend or reflect in accordance with the physical arrangement of the components in the display system 100.

Advantageously, the integrated component 102 provides both gamma control and polarization clean-up for the display system. As described above, the gamma control component 108 separates the gamma control function from the imaging function and the spatial light modulator 105 may include little or no gamma control circuitry, thereby reducing overall complexity and cost for the active display devices, while the wire grid clean-up polarizer 109 may provide a substantial improvement in base engine contrast.

With reference to FIG. 11, a display system 110 includes a light engine 111 and a projection subsystem 112, and utilizes a wire grid polarizer 113 as a polarization beam splitter. Light from the light engine 111 is directed to a red dichroic mirror 114 which reflects red light through the WGP 113 to a first LCOS panel 115 and passes blue and green light through the WGP 113 to a second LCOS panel 116. The LCOS panels 115, 116 may have associated additional optical components 117, such as filters, lenses, etc. A color switch subsystem (not shown) may switch blue and green light on the second LCOS panel 116.

Substantially polarized, modulated light from the first and second LCOS panels 11 5, 116 is reflected by the opposite side of the WGP 113 onto respective faces of a combining prism 118. In accordance with some embodiments of the invention, and as illustrated in FIG. 11, a single integrated gamma control and wire grid clean-up polarizer component 119 may be disposed on an exit face of the combining prism 118, proximate to the entrance aperture of the projections lens 112.

The integrated component 119 may reflect light of the wrong polarization back into the optical engine (e.g. various of components 113-118). In some embodiments, the integrated component 119 may be configured to lie outside a focal plane within the optical engine so the reflected light is not refocused onto an imaging surface.

Advantageously, the integrated component 119 provides both gamma control and polarization clean-up for the display system 110. As described above, the gamma control component separates the gamma control function from the imaging function and the two LCOS panels 115, 116 may include little or no gamma control circuitry, thereby reducing overall complexity and cost for the active display devices, while the wire grid clean-up polarizer may provide a substantial improvement in base engine contrast. Integrating the gamma control component as a single pixel liquid crystal cell between respective glass surfaces of the wire grid clean-up polarizer and the combining prism may reduce cost, part counts, and/or manufacturing complexity of the optical engine.

Even though single or two-panel (or two PBS) display systems have been described above, according to some embodiments, more or less panels may be utilized in various embodiments of the invention. In many embodiments, single or multi-panel-based color imaging systems may be devised without departing away from the spirit of the present invention. An example of a panel is a liquid crystal on silicon (LCOS) panel, forming screen projection displays in projection display systems. Consistent with numerous embodiments of the present invention, color schemes other than a red-green-blue (RGB) format may be employed since the RGB format is simply used here for illustration purposes only.

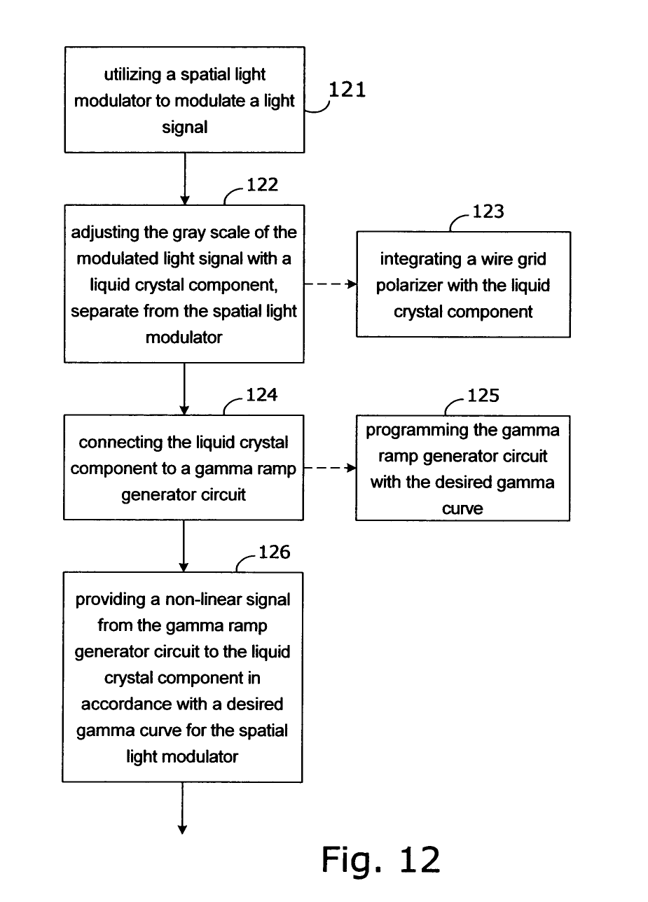

With reference to FIG. 12, some embodiments of the invention include utilizing a spatial light modulator to modulate a light signal (block 121), and adjusting the gray scale of the modulated light signal with a liquid crystal component, separate from the spatial light modulator (block 122). Some embodiments further include integrating a wire grid polarizer with the liquid crystal component (block 123). Some embodiments further include connecting the liquid crystal component to a gamma ramp generator circuit (block 124). Some embodiments further include programming the gamma ramp generator circuit with the desired gamma curve (block 125). Some embodiments further include providing a non-linear signal from the gamma ramp generator circuit to the liquid crystal component in accordance with a desired gamma curve for the spatial light modulator (block 126). The foregoing blocks 121-126 are not necessarily performed in a prescribed order. Blocks 121-126 may optionally be performed with various of blocks 21-23 from FIG. 2.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An apparatus, comprising:
an optical component disposed along an optical path; and
a clean-up polarizer disposed along the optical path with the optical component,
wherein the clean-up polarizer comprises a wire grid clean-up polarizer.

2. The apparatus of claim 1, wherein the optical component comprises a prism and wherein the wire grid clean-up polarizer is disposed on a face of the prism.

3. The apparatus of claim 1, wherein the optical component comprises a projection lens and wherein the wire grid clean-up polarizer is positioned proximate to an entrance aperture of the projection lens.

4. The apparatus of claim 1, further comprising:
a spatial light modulator disposed along the optical path and configured to modulate light; and
a liquid crystal component, separate from the spatial light modulator, disposed along the optical path and configured to provide gamma control for the modulated light.

5. The apparatus of claim 4, wherein the liquid crystal component comprises:
a first layer of glass disposed on the wire grid clean-up polarizer;
a second layer of glass positioned opposite of the first layer of glass; and
liquid crystal material disposed in between the first and second layers of glass.

6. The apparatus of claim 5, further comprising:
first and second coatings of indium titanium oxide (ITO) respectively disposed on the first and second layers of glass;
a gamma ramp generator circuit; and
first and second electrical connections respectively connected between the first and second ITO coatings and the gamma ramp generator circuit.

7. The apparatus of claim 6, wherein the gamma ramp generator circuit provides a non-linear electrical signal to the liquid crystal component in accordance with a desired gamma curve for the spatial light modulator.

8. The apparatus of claim 7, wherein the gamma curve is programmable.

9. A method, comprising:
generating a substantially polarized, modulated light signal; and
cleaning up the polarization of the light signal with a wire grid polarizer.

10. The method of claim 9, further comprising:
integrating the wire grid polarizer with another optical element.

11. The method of claim 10, wherein the optical element comprises a prism.

12. The method of claim 9, further comprising:
utilizing a spatial light modulator to modulate the light signal; and
adjusting the gray scale of the modulated light signal with a liquid crystal component, separate from the spatial light modulator.

13. The method of claim 12, further comprising:
integrating the wire grid polarizer with the liquid crystal component.

14. The method of claim 12, further comprising:
connecting the liquid crystal component to a gamma ramp generator circuit.

15. The method of claim 14, further comprising:
providing a non-linear signal from the gamma ramp generator circuit to the liquid crystal component in accordance with a desired gamma curve for the spatial light modulator.

16. The method of claim 15, further comprising:
programming the gamma ramp generator circuit with the desired gamma curve.

17. A system, comprising:
a spatial light modulator disposed along an optical path and configured to modulate light; and
a clean-up polarizer disposed along the optical path with the spatial light modulator,
wherein the clean-up polarizer comprises a wire grid clean-up polarizer.

18. The system of claim 17, further comprising:
a light engine configured to provide light along the optical path.

19. The system of claim 18, further comprising:
a display screen configured to display an image of the modulated light from the spatial light modulator.

20. The system of claim 17, further comprising:
a prism, wherein the wire grid clean-up polarizer is disposed on a face of the prism.

21. The system of claim 17, further comprising:
a projection lens, wherein the wire grid clean-up polarizer is positioned proximate to an entrance aperture of the projection lens.

22. The system of claim 17, further comprising:
a gamma control component, separate from the spatial light modulator, disposed along the optical path and configured to provide gamma control for the modulated light.

23. The system of claim 22, wherein the gamma control component comprises:
a first layer of glass disposed on the wire grid clean-up polarizer;
a second layer of glass positioned opposite of the first layer of glass;
liquid crystal material disposed in between the first and second layers of glass; and
first and second coatings of indium titanium oxide (ITO) respectively disposed on the first and second layers of glass.

24. The system of claim 23, further comprising:
a gamma ramp generator circuit connected to the gamma control component.

25. The system of claim 24, wherein the gamma ramp generator circuit provides a non-linear electrical signal to the gamma control component in accordance with a programmable gamma curve.

26. An apparatus, comprising:
a single pixel liquid crystal cell; and
a gamma ramp generator circuit coupled to the single pixel liquid crystal cell.

27. The apparatus of claim 26, wherein the single pixel liquid crystal cell comprises:
a first layer of glass;
a second layer of glass positioned opposite of the first layer of glass;
liquid crystal material disposed in between the first and second layers of glass;
first and second coatings of indium titanium oxide (ITO) respectively disposed on the first and second layers of glass; and
first and second electrical connections respectively connected between the first and second ITO coatings and the gamma ramp generator circuit.

28. The apparatus of claim 26, wherein the gamma ramp generator circuit provides a non-linear electrical signal to the liquid crystal component in accordance with a desired gamma curve.

29. The apparatus of claim 29, wherein the gamma curve is programmable.

30. The apparatus of claim 26, further comprising:
a spatial light modulator separate from the single pixel liquid crystal cell and disposed along an optical path with the single pixel liquid crystal cell.
